(19) United States
(12) Patent Application Publication
(10) Pub. No.: US 2025/0183554 A1
(43) Pub. Date: Jun. 5, 2025

(54) ANTENNA STRUCTURE, ANTENNA ARRAY AND ANTENNA MODULE

(71) Applicant: Universal Global Technology (Huizhou) Co., Ltd., Guangdong Province (CN)

(72) Inventors: CHANG WEI LIN, Guangdong Province (CN); CHIA CHUN WENG, Guangdong Province (CN); HUNG WEI CHIU, Guangdong Province (CN); JUI CHIH CHIEN, Guangdong Province (CN)

(21) Appl. No.: 18/950,200

(22) Filed: Nov. 18, 2024

(30) Foreign Application Priority Data
Dec. 4, 2023 (CN) 202311654589.2

(51) Int. Cl. H01Q 21/06; H01Q 1/28; H01Q 13/16

(52) U.S. Cl. CPC H01Q 21/064; H01Q 13/16; H01Q 1/288

(57) ABSTRACT

An antenna structure includes an antenna unit, at least one feeding portion and a substrate. The antenna unit includes a first radiation portion, a second radiation portion and two contacting portions. The second radiation portion surrounds the first radiation portion, and there is a gap between the first radiation portion and the second radiation portion. The two contacting portions are connected to the first radiation portion and the second radiation portion, and are spaced apart from each other. The at least one feeding portion is connected to the second radiation portion. The antenna unit and the at least one feeding portion are respectively disposed on two opposite surfaces of the substrate. The gap is divided into a first slot and a second slot by the two contacting portions.

### RELATED APPLICATIONS

This application claims priority to China Application Serial Number 202311654589.2, filed Dec. 4, 2023, which is herein incorporated by reference.

### BACKGROUND

### Technical Field

The present disclosure relates to an antenna structure, an antenna array and an antenna module. More particularly, the present disclosure relates to an antenna structure, an antenna array and an antenna module, which are applied to Low-Orbit Satellites (LEO).

### Description of Related Art

As the development of the communication system being universal, signals can be extended to the areas, which are hard to reach, such as highway and remote villages by satellites. Internet of things, broadcast, or other communication behaviors with high delay tolerance can be achieved. Therefore, communication of LEO is gradually emphasized.

Thus, an antenna structure, an antenna array and an antenna module, which have a simple structure and low cost, are commercially desirable.

### SUMMARY

According to one aspect of the present disclosure, an antenna structure includes an antenna unit, at least one feeding portion and a substrate. The antenna unit includes a first radiation portion, a second radiation portion and two contacting portions. The second radiation portion surrounds the first radiation portion. There is a gap between the first radiation portion and the second radiation portion. Two contacting portions are connected to the first radiation portion and the second radiation portion, and spaced apart from each other. The at least one feeding portion is connected to the second radiation portion. The antenna unit and the at least one feeding portion are respectively disposed on two opposite surfaces of the substrate. The gap is divided into a first slot and a second slot by the two contacting portions.

According to another aspect of the present disclosure, an antenna array includes a plurality of antenna structures of the aforementioned aspect. Each of the antenna structures further includes a center point. There is a first line between the center point of one of the antenna structures and another center point of another one of the antenna structures adjacent thereto. There is a second line between the center point of the one of the antenna structures and further another center point of further another one of the antenna structures adjacent thereto. An angle is formed between the first line and the second line, and the angle is 60 degrees.

According to further another aspect of the present disclosure, an antenna module includes an antenna structure and a phase distributor. The antenna structure includes an antenna unit, two feeding portions and a substrate. The antenna unit includes a first radiation portion, a second radiation portion and two contacting portions. The second radiation portion surrounds the first radiation portion. There is a gap between the first radiation portion and the second radiation portion. The two contacting portions are connected to the first radiation portion and the second radiation portion, and spaced apart from each other. The two feeding portions are connected to the second radiation portion. The antenna unit is disposed on a surface of the substrate, and the two feeding portions are disposed on another surface of the substrate. The phase distributor is connected to the two feeding portions, configured to transform two input signals into two feeding signals and inputted the two feeding signals to the two feeding portions. A phase difference is between the two feeding signals. The gap is divided into a first slot and a second slot by the two contacting portions.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of an antenna structure according to a first embodiment of the present disclosure.

FIG. 2 shows an exploded view of the antenna structure of FIG. 1.

FIG. 3 shows a side view of the antenna structure of FIG. 1.

FIG. 4 shows a comparative schematic view of a S-parameter of the antenna structure of FIG. 1.

FIG. 5 shows a schematic view of an antenna array according to a second embodiment of the present disclosure.

FIG. 6 shows a schematic view of an antenna module according to a third embodiment of the present disclosure.

### DETAILED DESCRIPTION

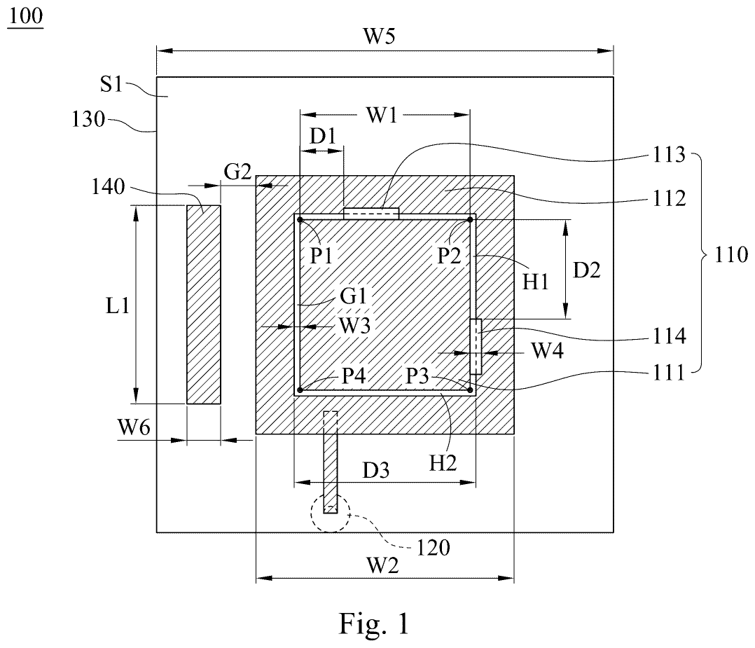

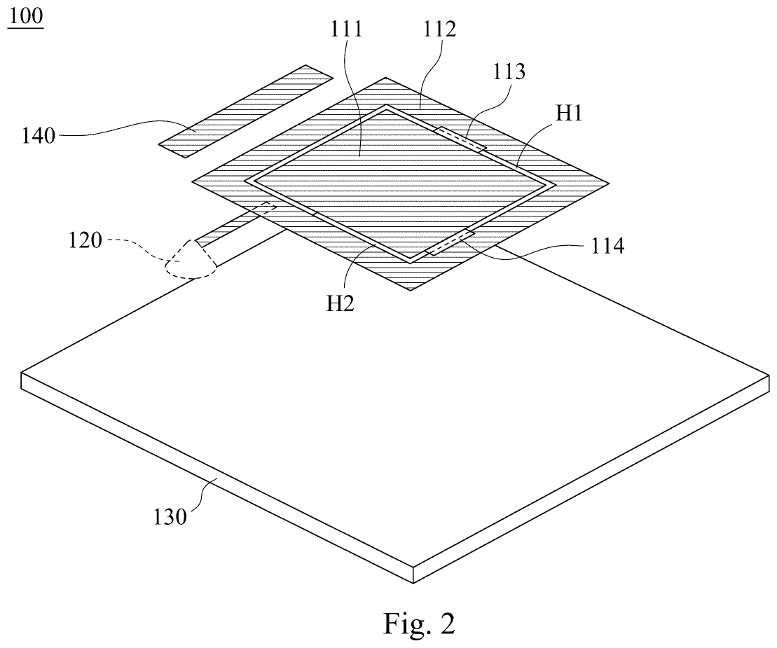

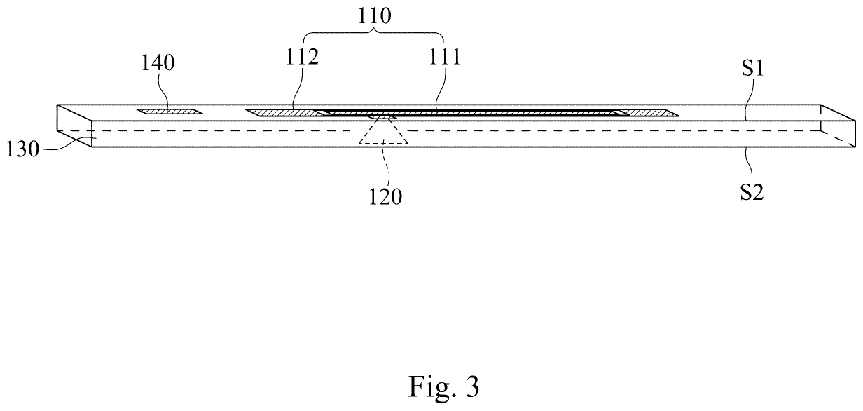

Please refer to FIG. 1 to FIG. 3. FIG. 1 shows a schematic view of an antenna structure 100 according to a first embodiment of the present disclosure. FIG. 2 shows an exploded view of the antenna structure 100 of FIG. 1. FIG. 3 shows a side view of the antenna structure 100 of FIG. 1. The antenna structure 100 includes an antenna unit 110, at least one feeding portion 120 and a substrate 130. The antenna unit 110 includes a first radiation portion 111, a second radiation portion 112 and two contacting portions 113, 114. The second radiation portion 112 surrounds the first radiation portion 111. There is a gap G1 between the first radiation portion 111 and the second radiation portion 112. Two contacting portions 113, 114 are connected to the first radiation portion 111 and the second radiation portion 112, and spaced apart from each other. The feeding portion 120 is connected to the second radiation portion 112. The antenna unit 110 and the feeding portion 120 are respectively disposed on two opposite surfaces (i.e., a first surface S1 and a second surface S2 (shown in FIG. 3)) of the substrate 130. The gap G1 is divided into a first slot H1 and a second slot H2 by the two contacting portions 113, 114.

In detail, the substrate 130 can be a RO3003 printed circuit board or other sheet materials with low consumption characteristic while operated at high frequency band, but the present disclosure is not limited thereto. The first radiation portion 111 and the second radiation portion 112 can be a patch antenna printed on the substrate 130 integrally, and the gap G1 can be etched in the middle of the patch antenna, so as to form the first radiation portion 111 and the second radiation portion 112. Any of the contacting portions 113, 114 contacts the first radiation portion 111 and the second radiation portion 112 at the same time, and crosses the gap G1. The contacting portions 113, 114 are spaced apart from each other. A part of the gap G1, which is not covered by the contacting portions 113, 114, is defined as the first slot H1 and the second slot H2.

The antenna structure 100 has a first resonant frequency band and a second resonant frequency band. The first resonant frequency band is corresponding to the first radiation portion 111, and the second resonant frequency band is corresponding to the second radiation portion 112. In the first embodiment, the first resonant frequency band is 30 GHZ, and the second resonant frequency band is 20 GHZ, the aforementioned two resonant frequency bands can cover a Ka band in the LEO system, but the present disclosure is not limited thereto. Thus, the antenna structure 100 of the present disclosure can excite dual frequency bands by etching the gap G1 on the patch antenna, thereby covering the Ka band in the LEO system by a simple structure.

Moreover, a width W1 of the first radiation portion 111 is corresponding to a quarter of a wavelength of the first resonant frequency band, and a width W2 of the second radiation portion 112 is corresponding to a quarter of a wavelength of the second resonant frequency band. The gap G1 has a width W3, and the width W3 is larger than or equal to 0.07 mm, and less than or equal to 0.15 mm. Any of the contacting portions 113, 114 has a width W4, and the width W4 is larger than 0.08 mm, and less than or equal to 0.3 mm. In the first embodiment, the width W1 can be 2.5 mm, the width W2 can be 3.8 mm, the width W3 can be 0.08 mm, and the width W4 can be 1 mm, but the present disclosure is not limited thereto.

Thus, the antenna structure 100 of the present disclosure can couple the first radiation portion 111 and the second radiation portion 112 to generate dual-frequency band resonance without enhancing an area of the antenna unit 110 by adding the first slot H1 and the second slot H2 in the antenna unit 110 so as to correspond the frequency of the antenna unit 110 to a quarter of a wavelength of the antenna unit 110.

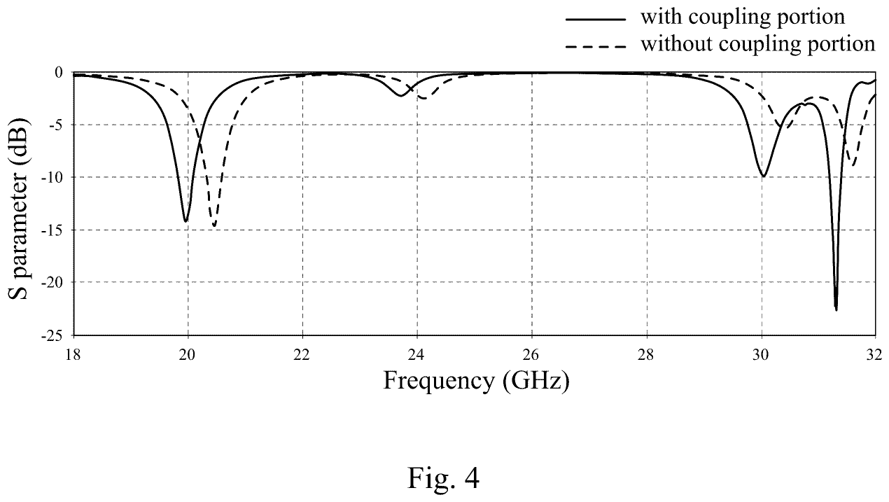

Please refer to FIG. 1 to FIG. 4. FIG. 4 shows a comparative schematic view of a S-parameter of the antenna structure 100 of FIG. 1. The antenna structure 100 can further include a coupling portion 140. The coupling portion 140 is disposed on the substrate 130, and there is an interval G2 between the coupling portion 140 and the second radiation portion 112. By adjusting a length L1, a width W6 of the coupling portion 140 or the interval G2 between the coupling portion 140 and the antenna unit 110 can fine-tune the first resonant frequency band and the second resonant frequency band. In the first embodiment, the length L1 of the coupling portion 140 can be 2.9 mm, a width W5 of the substrate 130 can be 6.8 mm, and the width W6 of the coupling portion 140 can be 0.5 mm, and the interval G2 between the coupling portion 140 and the antenna unit 110 can be 0.5 mm, but the present disclosure is not limited thereto. FIG. 4 shows an S-parameter comparison between the antenna structure 100 with the coupling portion 140 and without the coupling portion. The coupling portion 140 can correct and adjust the first resonant frequency band and the second resonant frequency band into the requirement frequency band. Thus, the antenna structure 100 of the present disclosure can match the first resonant frequency band and the second resonant frequency band to the Ka band of the LEO system accurately via the coupling portion 140.

Further, both of the first radiation portion 111 and the second radiation portion 112 are regular quadrilateral, the first radiation portion 111 has four endpoints P1, P2, P3, P4. A distance D1 between one (e.g., the contacting portion 113) of the two contacting portions 113, 114 and one (e.g., the endpoint P1) of the four endpoints P1, P2, P3, P4 is larger than or equal to 0.53 mm and less than or equal to 0.93 mm, and another distance D2 between another one (e.g., the contacting portion 114) of the two contacting portions 113, 114 and another one (e.g., the endpoint P2) of the four endpoints P1, P2, P3, P4 is larger than or equal to 1.25 mm and less than or equal to 1.65 mm. In the first embodiment, the distance D1 can be 0.73 mm, the distance D2 can be 1.45 mm, and the outermost distance D3 of the gap G1 can be 2.66 mm, but the present disclosure is not limited thereto.

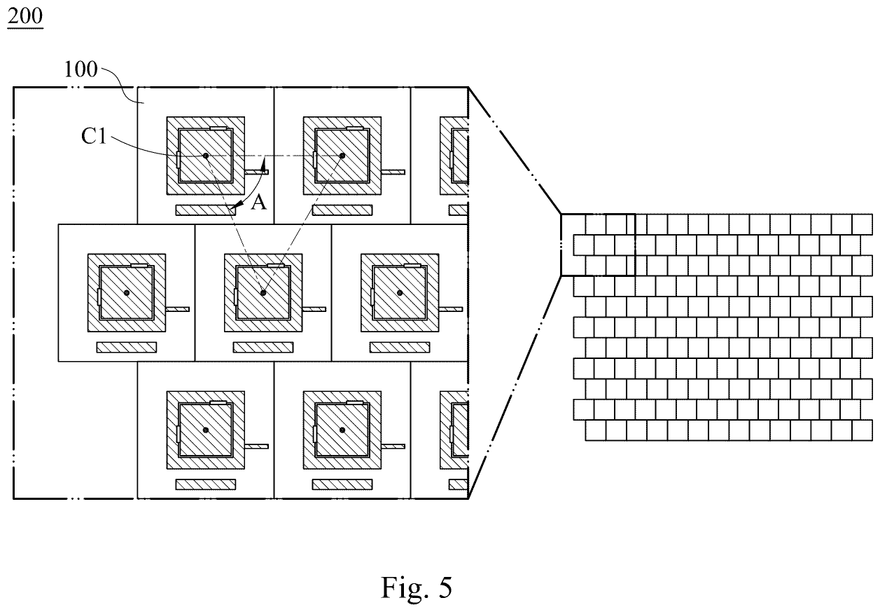

Please refer to FIG. 1 and FIG. 5. FIG. 5 shows a schematic view of an antenna array 200 according to a second embodiment of the present disclosure. The antenna array 200 includes a plurality of the aforementioned antenna structures 100. Each of the antenna structures 100 further includes a center point C1. There is a first line between the center point C1 of one of the antenna structures 100 and another center point C1 of another one of the antenna structures 100 adjacent thereto (the another one of the antenna structures 100 is adjacent to the one of the antenna structures 100). There is a second line between the center point C1 of the one of the antenna structures 100 and further another center point C1 of further another one of the antenna structures 100 adjacent thereto (the further another one of the antenna structures 100 is adjacent to the one of the antenna structures 100). An angle A is formed between the first line and the second line, and the angle A is 60 degrees. That is, the adjacent seven antenna structures 100 can form a regular hexagon.

In other words, the antenna structure 100 of the second embodiment is the same as the antenna structure 100 of the first embodiment, and will not be described again. The antenna structures 100 in the Nth column of the antenna array 200 are arranged dislocated to the antenna structures 100 in the N+1th column of the antenna array 200. Thus, the scanning angle of the second resonant frequency band during beam forming can be increased from negative or positive 30 degrees to negative or positive 60 degrees. Thus, the antenna array 200 of the present disclosure can increase the beam forming scanning angle by arranging the antenna structures 100 in a honeycomb manner.

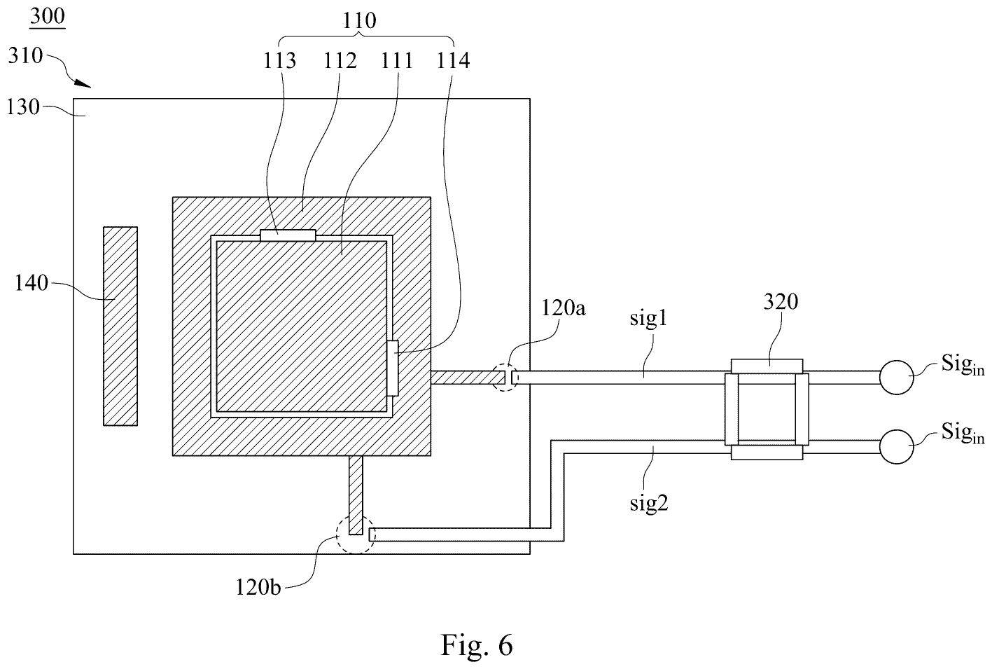

Please refer to FIG. 1 to FIG. 6. FIG. 6 shows a schematic view of an antenna module 300 according to a third embodiment of the present disclosure. An antenna module 300 includes an antenna structure 310 and a phase distributor 320. The antenna structure 310 includes an antenna unit 110, two feeding portions 120a, 120b, a substrate 130 and a coupling portion 140. The phase distributor 320 is connected to the two feeding portions 120a, 120b. The phase distributor 320 is configured to transform two input signals Sigᵢₙ into two feeding signals sig1, sig2 and inputted the two feeding signals sig1, sig2 to the two feeding portions 120a, 120b. A phase difference is between the two feeding signals sig1, sig2. The antenna unit 110, any one of the feeding portions 120a, 120b, the substrate 130 and the coupling portion 140 are the same as the antenna unit 110, the feeding portion 120, the substrate 130 and the coupling portion 140 of the antenna structure 100 of the first embodiment, respectively. Further, in the third embodiment, the number of the feeding portions 120a, 120b of the antenna structure 310 is two.

In detail, the phases of the two input signals Sigᵢₙ are the same, and the two input signals Sigᵢₙ can be transformed into the feeding signals sig1, sig2, which have a phase difference therebetween, by the phase distributor 320. When there is a phase difference between the feeding signal sig1 of the feeding portion 120a and the feeding signal sig2 of the feeding portion 120b, the panel antenna with linear polarization characteristic can be transformed into the panel antenna with circularly polarization characteristic (i.e., linear polarization characteristic of the antenna module 300 (such as the panel antenna) can be transformed into circularly polarization characteristic). Thus, the gain of the antenna module 300 of the present disclosure can be increased.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna structure, comprising:
an antenna unit, comprising:
a first radiation portion;
a second radiation portion surrounding the first radiation portion, wherein there is a gap between the first radiation portion and the second radiation portion; and
two contacting portions connected to the first radiation portion and the second radiation portion, and spaced apart from each other;
at least one feeding portion connected to the second radiation portion; and
a substrate, wherein the antenna unit and the at least one feeding portion are respectively disposed on two opposite surfaces of the substrate;
wherein the gap is divided into a first slot and a second slot by the two contacting portions.

2. The antenna structure of claim 1, further comprising:
a coupling portion disposed on the substrate, wherein there is an interval between the coupling portion and the second radiation portion.

3. The antenna structure of claim 1, wherein the antenna structure has a first resonant frequency band and a second resonant frequency band, the first resonant frequency band is corresponding to the first radiation portion, and the second resonant frequency band is corresponding to the second radiation portion.

4. The antenna structure of claim 3, wherein the first resonant frequency band is 30 GHz, and the second resonant frequency band is 20 GHz.

5. The antenna structure of claim 3, wherein a width of the first radiation portion is corresponding to a quarter of a wavelength of the first resonant frequency band, and a width of the second radiation portion is corresponding to a quarter of a wavelength of the second resonant frequency band.

6. The antenna structure of claim 1, wherein both of the first radiation portion and the second radiation portion are regular quadrilateral, the first radiation portion has four endpoints, a distance between one of the two contacting portions and one of the four endpoints is larger than or equal to 0.53 mm and less than or equal to 0.93 mm, and another distance between another one of the two contacting portions and another one of the four endpoints is larger than or equal to 1.25 mm and less than or equal to 1.65 mm.

7. The antenna structure of claim 1, wherein the gap has a width, and the width is larger than or equal to 0.07 mm, and less than or equal to 0.15 mm.

8. The antenna structure of claim 1, wherein any one of the two contacting portions has a width, and the width is larger than 0.08 mm, and less than or equal to 0.3 mm.

9. An antenna array, comprising:
a plurality of the antenna structures of claim 1, each of the antenna structures further comprising a center point;
wherein there is a first line between the center point of one of the antenna structures and another center point of another one of the antenna structures adjacent thereto, there is a second line between the center point of the one of the antenna structures and further another center point of further another one of the antenna structures adjacent thereto, an angle is formed between the first line and the second line, and the angle is 60 degrees.

10. An antenna module, comprising:
an antenna structure, comprising:
an antenna unit, comprising:
a first radiation portion;
a second radiation portion surrounding the first radiation portion, wherein there is a gap between the first radiation portion and the second radiation portion; and
two contacting portions connected to the first radiation portion and the second radiation portion, and spaced apart from each other;
two feeding portions connected to the second radiation portion; and
a substrate, wherein the antenna unit is disposed on a surface of the substrate, and the two feeding portions are disposed on another surface of the substrate; and
a phase distributor connected to the two feeding portions, configured to transform two input signals into two feeding signals and inputted the two feeding signals to the two feeding portions, wherein a phase difference is between the two feeding signals;
wherein the gap is divided into a first slot and a second slot by the two contacting portions.
